(19) United States
(12) Patent Application Publication
(10) Pub. No.: US 2008/0074230 A1
(43) Pub. Date: Mar. 27, 2008

(54) VARIABLE PERMEABILITY INDUCTOR CRE STRUCTURES

(75) Inventors: Chingchi Chen, Ann Arbor, MI (US); Feng Liang, Canton, MI (US); Michael Degner, Novi, MI (US)

Correspondence Address: Dickinson Wright PLLC, 38525 Woodward Avenue, Suite 2000, Bloomfield Hills, MI, 48304, US

(73) Assignee: Ford Motor Company, Dearborn, MI (US)

(21) Appl. No.: 11/534,055

(22) Filed: Sep. 21, 2006

(51) Int. Cl. H01F 27/24

(52) U.S. Cl. 336/212

(57) ABSTRACT

An inductor L may include a core 140 that has a member 141 with multiple material zones 142. The material zones 142 have associated saturation flux density and permeability. A winding 194 is coupled to the member 141 and is configured for magnetic flux generation in the core 140. An inductor 180 may also or alternatively include a core 192, which has a member 198 with a gap 188, and a permeability-varying member 182. The core 192 has a first saturation flux density. The permeability-varying member 182 is disposed within the gap 188 and has a second saturation flux density that is less than the first saturation flux density.

### TECHNICAL FIELD

The present invention relates to vehicle and non-vehicle electronic and electrical systems, components, and circuits. More particularly, the present invention is related to the effective permeability and thus the inductance of inductor core structures.

### BACKGROUND OF THE INVENTION

A variety of inductor structures currently exist and are utilized throughout industry for numerous purposes. The inductors may be utilized, for example, in hybrid electric vehicles, fan drives, washing machines, refrigerators, and other various machines and equipment to improve efficiency and performance, to minimize noise, or to perform other tasks commonly associated therewith.

An inductor typically is formed of a ferromagnetic core, which may be rectangular-shaped, and has one or more windows. One or more windings are wound about associated segments of the core. Electrical current supplied to the windings creates a magnetic flux in the core. To prevent the core from becoming saturated during a heavily loaded condition, the core often has one or more low permeability gaps. The low permeability gap reduces the effective permeability of the core and thus the inductance therein. As such, the core is not fully utilized at light load. In general, as gap length increases permeability and inductance decrease. This is significant drawback for systems operating primarily at light load.

Thus, there exists a need for an improved inductor or inductor structure that overcomes the above-described disadvantages of prior core structures.

### SUMMARY OF THE INVENTION

In one embodiment of the present invention an inductor is provided that includes a core that has a member with multiple material zones. The material zones have associated saturation flux density. A winding is coupled to the member and is configured for magnetic flux generation in the core.

In another embodiment of the present invention an inductor is provided that includes a core, which has members with gaps, and permeability-varying members. The core has a first saturation flux density. The permeability-varying members are disposed within the gaps and have saturation flux densities that are less than the first saturation flux density. At least one winding is coupled to the member and are configured for magnetic flux generation in the core.

The embodiments of the present invention provide several advantages. One advantage provided by an embodiment of the present invention is an inductor that has at least one zone or member that has high permeability during low loading conditions and low permeability during high loading conditions. This also increases inductor material utilization for improved flux density at low current while providing desired inductance during high loading conditions without the inductor overheating.

Another advantage provided by an embodiment of the present invention is an inductor that is tunable for a desired permeability and inductance for a predetermined loading condition.

Yet another advantage provided by another embodiment of the present invention is the ability to provide an inductor with high permeability during low loading conditions and low permeability during high loading conditions and that has controlled or limited losses, such as eddy current loss or hysteresis loss.

The present invention is versatile in that it provides a variety of configurations that may be utilized, varied, adjusted, and tuned for a diverse range of electronic circuits, industries, and applications.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a side view of a traditional inductor having a magnetic flux path perpendicularly oriented gap;

FIG. 2 is a side view of a traditional inductor having a tilted gap;

FIG. 3 is a side view of a traditional inductor core having multiple gaps;

FIG. 4 is a side view of an inductor core having distributed and evenly spread gaps;

FIG. 5 is a schematic view of a sample electronic circuit incorporating an inductor with members or material zones having different magnetic saturation flux density in accordance with an embodiment of the present invention;

FIG. 6 is a side view of an inductor core having multiple material zones with different magnetic saturation flux density in accordance with an embodiment of the present invention;

FIG. 7 is a side close-up view of a portion of an inductor core having a serial structure in accordance with an embodiment of the present invention;

FIG. 8 is a side close-up view of a portion of an inductor core having a parallel structure in accordance with another embodiment of the present invention;

FIG. 9 is a side close-up view of a portion of an inductor core having both a serial and parallel structure in accordance with another embodiment of the present invention;

FIG. 10 is a side view of an inductor incorporating a permeability-varying member in a perpendicular magnetic flux flow orientation in accordance with still another embodiment of the present invention;

FIG. 11 is a side view of an inductor incorporating a permeability-varying member in a tilted magnetic flux flow orientation in accordance with yet another embodiment of the present invention;

FIG. 12 is a side view of an inductor core incorporating member edge gaps in accordance with another embodiment of the present invention;

FIG. 13 is a side view of an inductor core incorporating rectangular-shaped internal member gaps in accordance with another embodiment of the present invention; and

FIG. 14 is a side view of an inductor core incorporating hexagonally-shaped internal member gaps in accordance with another embodiment of the present invention.

### DETAILED DESCRIPTION

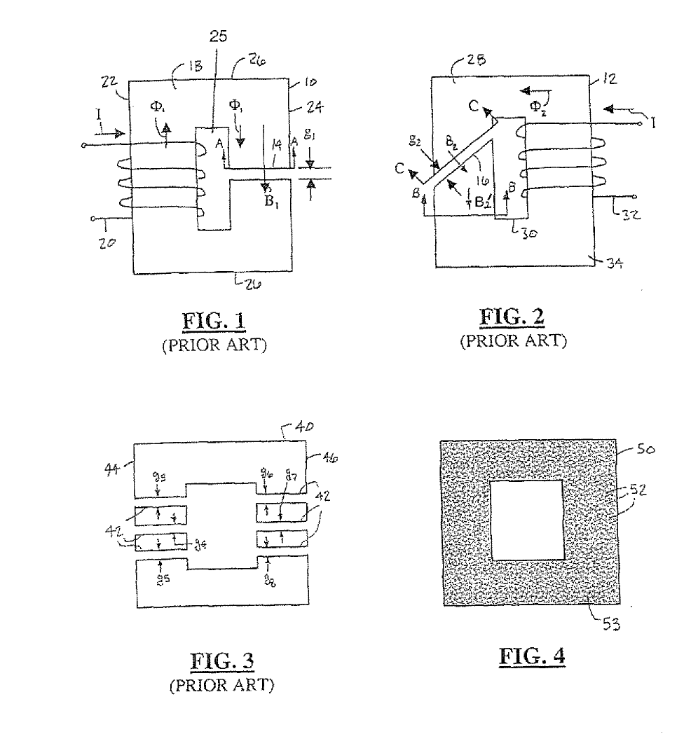

Referring now to FIGS. 1 and 2, side views of a first traditional inductor 10 and a second traditional inductor 12. The first inductor 10 has a lateral gap 14 that is oriented approximately perpendicular to a magnetic flux path Φ₁. The second inductor 12 has a tilted gap 16. The first inductor 10 includes a first core 18 and a first window 25 winding 20 that are rectangularly-shaped. The winding 20 is wound about a first member 22 of the first core 18. The lateral gap 14 extends across a second member 24 opposite the first member 22. The magnetic flux flow path Φ₁ follows and is defined by the members 22, 24, and 26 of the first core 18.

The second inductor 12 is similar to the first inductor 10. However, instead of having a perpendicularly oriented gap, the second inductor 12 has the diagonally oriented or tilted gap 16. The tilted gap 16 is in a non-perpendicular arrangement relative to the magnetic flux flow path Φ₂ passing through the second inductor 12. The second inductor 12 has a second core 28 with a second window 30. A winding 32 is wound about a core member 34, opposite the tilted gap 16, of the core 28.

The gaps 14 and 16 prevent saturation of the cores 18 and 28 during high loading conditions. A “high loading condition” refers to a condition in which a substantial amount of magnetic flux is generated due to a large amount of current through the winding(s). Since air gaps have a relative permeability μᵣ that is approximately equal to one, the gaps 14 and 16 can be sized properly to prevent core saturation. Of course, in general, the larger the gap the smaller the overall effective permeability.

Since the cores of an inductor are commonly formed of ferromagnetic materials to facilitate inductance, it is assumed that the cores 18 and 28 have a substantially higher permeability than the gaps 14 and 16. As such, the flux densities B₁ and B₂ through the gaps 14 and 16 are estimated by respective equations 1 and 2 for the first inductor 10 and the second inductor 12.

$$\begin{matrix}{B}_{1} = {μ}_{1} \frac{{N}_{1} {I}_{1}}{{g}_{1}} & ( 1 ) \\ {B}_{2} = {μ}_{2} \frac{{N}_{2} {I}_{2}}{{g}_{2}} & ( 2 )\end{matrix}$$

The flux densities B₁ and B₂ are provided in relation to the equivalent permeability μₓ of the gaps 14 and 16, the number of turns of the windings Nₓ, and the associated winding current Iₓ, where x represents the inductor of concern. It is assumed that the equivalent cross-sectional area A₁ of the first gap 14 and the equivalent cross-sectional area A₂ of the second gap 16 are uniform. The cross-sectional area A₁ is taken through section line A-A of FIG. 1. It is assumed that the cross-section area taken through the section line B-B of FIG. 2 is also A₁. The cross-sectional area A₂ is taken through the section line C-C of FIG. 2. It is also assumed that the overall flux Φ₁ and Φ₂ for each of the cores 18 and 28 is approximately the same and with the same gap permeabilities (μ=μ₁=μ₂) windings (N=N₁=N₂), and input currents (I=I₁=I₂), as represented by equation 3.

$${Φ}_{1} = {B}_{1} {A}_{1} = μ \frac{{NIA}_{1}}{{g}_{1}} = {Φ}_{2} = {B}_{2} {A}_{2} = μ \frac{{NIA}_{2}}{{g}_{2}} \qquad ( 3 )$$

### Thus, relationships provided by equations 4 and 5 hold true.

$$\begin{matrix}\frac{{A}_{x}}{{g}_{x}} = \frac{{A}_{1}}{{g}_{1}} = \frac{{A}_{2}}{{g}_{2}} & ( 4 ) \\ {B}_{1} = {B}_{2}^{′} = {B}_{2} \frac{{A}_{2}}{{A}_{1}} & ( 5 )\end{matrix}$$

### Note that the flux density B₂ is smaller than B₁ and B₂′. Further, the inductance L of the cores 18 and 28 is provided by equation 6.

$$L = \frac{N Φ}{I} = μ \frac{{N}^{2} A}{g} \qquad ( 6 )$$

To prevent excessive core saturation, the lengths of the gaps g₁ and g₂ are selected using equation 7 such that the cores 18 and 28 are not saturated at a maximum current Iₘₐₓ.

$${g}_{x} > μ \frac{{NI}_{max}}{{B}_{xsat}} \qquad ( 7 )$$

### The maximum flux density without excessive core saturation for each of the cores 18 and 28 is represented by Bₓₛₐₜ.

Referring now to FIG. 3, a side view of a traditional inductor core 40 that has multiple gaps 42 is shown. In general, inductors may have multiple cores, windings, and gaps. As an example, the inductor 40 is shown and has six gaps 42, with associated gap lengths g₃-g₈, three gaps on a first member 44 and three gaps on a second member 46. The effective overall gap length g_{T} that is associated with the inductor core 40 is equal to the sum of the gap lengths g₃-g₈, as represented by equation 8.

g_{T}=g₃+g₄+g₅+g₆+g₇+g₈ (8)

### The overall gap length g_{T} is such to prevent the inductor core 40 from becoming saturated at full load.

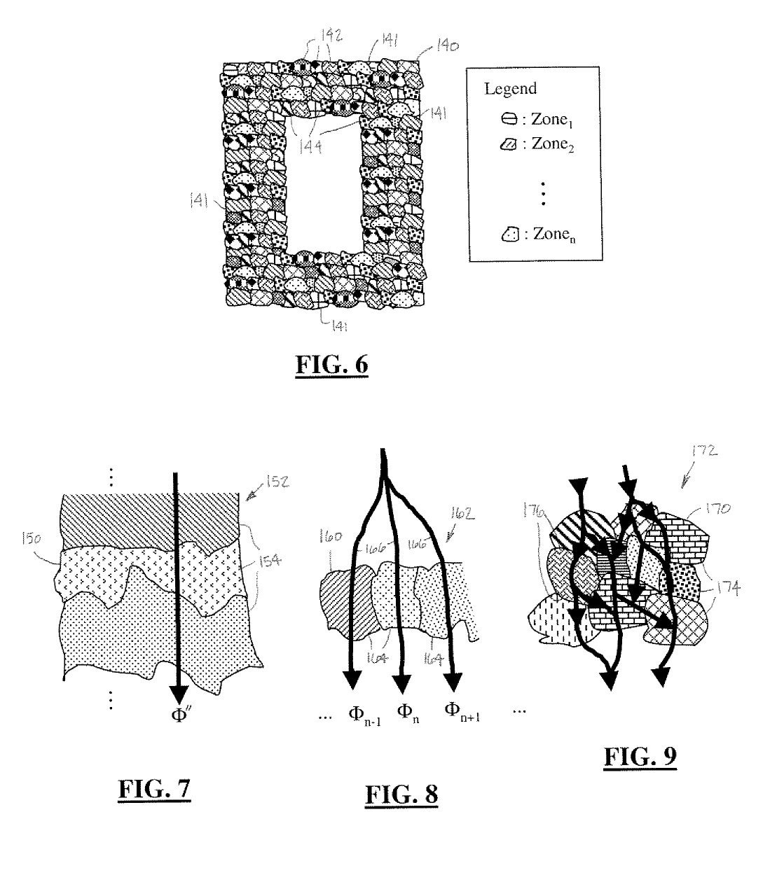

Referring now to FIG. 4, a side view of an inductor core 50 that has distributed and evenly spread gaps 52 is shown. To extend along the above-described approach, the gaps 52 of an inductor core 50 may be distributed. The gaps 52 have low-μ and are spread out evenly across the inductor core 50, which has a high-μ. This is represented by the pattern 53. The gaps 52 are abundant and infinitesimally small. As a result, there are an infinite number or an abundant number of high-μ zones and air gaps that are mixed together to provide a texture with a micro-structure that is similar to the structure of the inductor core 140 of FIG. 6. However, the difference between the inductor core 50 and the inductor core 140 is that the inductor core 50 contains plain gap materials, usually with relative permeability of 1. On the other hand, the inductor core 140 has many different zones, some of them are with self-adjusting permeabilities, as described below.

Some embodiments of the present invention, combine materials with low saturation density with the high-saturation main materials. The lower saturation density materials become saturated and serve as low permeable spacers to prevent the high-saturation materials from being saturated. This provides a structure with smart or self-adjusting gap equivalent zones.

In each of the following figures, the same reference numerals are used to refer to the same components. The present invention may apply to automotive, aeronautical, nautical, and railway applications, as well as to other applications in which inductors are utilized. The present invention may be applied in commercial and non-commercial settings. The present invention may be applied in appliances, in trailers, off-highway equipment, in auxiliary equipment, in communication systems, and in a variety of other applications or settings.

Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

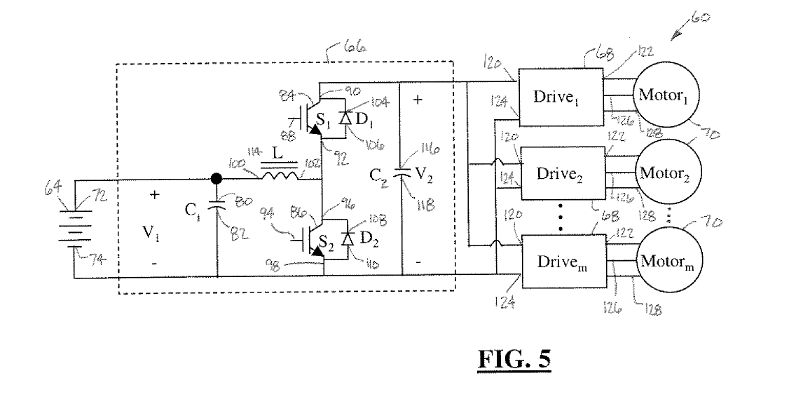

Referring now to FIG. 5, a schematic view of a sample electronic circuit 60 incorporating an inductor L with members or material zones having different magnetic saturation flux density is shown in accordance with an embodiment of the present invention (although not shown in FIG. 5, examples of such members and material zones are shown in FIGS. 6-14). Although the sample electronic circuit 60 is shown in association with a direct current (DC)-to-DC boost converter, the present invention is not meant to be limited to DC-to-DC converters and may be applied to various other known electronic circuits. Any of the inductors in FIGS. 6-14 and described herein or derived from the teachings herein may be utilized in the embodiment associated with FIG. 5 and in other embodiments of the present invention.

The electronic circuit 60 includes a power source 64, a DC-to-DC boost converter 66, electronic drives 68, and motors 70. The DC-to-DC converter 66 receives power from the power source 64 having an input voltage V₁. The power source 64 has a source terminal 72 and a ground terminal 74. The DC-to-DC converter 66 increases the voltage level to V₂, which is received by the drives 68. The drives 68 are used in the powering, controlling, and communicating with the motors 70.

The DC-to-DC converter 66 includes a first capacitor C₁ is coupled and parallel to the power source 64. The first capacitor C₁ has a first positive terminal 80 and a first negative terminal 82. The first negative terminal 82 is coupled to the ground terminal or ground 74.

The DC-to-DC converter 66 also includes a first switch 84 and a second switch 86, which are in series. The first switch 84 has a first base 88, a first collector 90, and a first emitter 92. The second switch 86 has a second base 94, a second collector 96, and a second emitter 98. The second switch 86 is coupled and parallel to the first capacitor C₁. The first emitter 92 is coupled to the second collector 96. The second emitter 98 is coupled to the ground terminal 74. The bases 88 and 94 may be coupled to or receive power from a controller (not shown) for activation of the switches 84 and 86.

The inductor L is coupled in series with the power source 64 and has an input terminal 100 and an output terminal 102. The input terminal 100 is coupled to first positive terminal 80. The output terminal 102 is coupled to the first emitter 92 and the second collector 96. The inductor L is design tunable to have a desired permeability during low and high loading conditions. With proper geometry design and material selection, the overall permeability at full load is tunable to match that of inductor cores that have low-μ gaps. The overall permeability is provided without excessive losses and is high during low current conditions. This is further described below with respect to the example embodiments of FIGS. 6-14.

Diodes D₁ and D₂ are coupled across the switches 84 and 86. The first diode D₁ has a first cathode terminal 104 and a first anode terminal 106. The first cathode terminal 104 is coupled to the first collector 90. The first anode terminal 106 is coupled to the first emitter 92. The second diode D₂ has a second cathode terminal 108 and second anode terminal 110. The second cathode terminal 108 is coupled to the second collector 96 The second anode terminal 110 is coupled to the second emitter 98.

A second capacitor C₂ is coupled and parallel to the switches 84 and 86. The second capacitor C₂ has a second positive terminal 116, which is coupled to the first collector 90, and a second negative terminal 118, which is coupled to the second emitter 98. The output voltage V₂ Of the DC-to-DC converter 66 may be measured across the second capacitor C₂.

The drives 68 have associated positive input terminals 120, negative input terminals 124, and three-phase output terminals 122, 126, and 128. The positive input terminals 120 are coupled to the second positive terminal 116, the negative input terminals 124 are coupled to the second negative terminal 118, and the three-phase output terminals 122, 126, and 128 are connected to motors 70.

Referring now to FIG. 6, a side view of an inductor core 140 having multiple material zones 142 with different saturation magnetic flux density is shown in accordance with an embodiment of the present invention. The inductor core 140 consists of multiple members 141 with material zones 142 that have arbitrary boundaries 144. The number, size, shape, pattern, and layout of the zones 142 may vary per application.

Each zone 142 has a designated permeability and magnetic saturation flux density. In one embodiment, the majority of the material zones 142 have a high permeability unless they are saturated. The material zones 142 may have varying or approximately equal permeability. On the other hand, some of the material zones 142 have a relatively high magnetic saturation flux density (high-Bₛₐₜ zones), whereas other material zones have a relatively low magnetic saturation flux density (low-Bₛₐₜ zones). When the low-Bₛₐₜ zones become saturated, such as during high loading or high flux density situations, they have low permeability approaching or similar to that of an air gap. In other words, the effective permeability of the zones with low saturation flux density vary substantially under different loading conditions. This prevents other zones from being saturated in high loading conditions. Materials, population density, and shapes of the low-Bₛₐₜ zones are selected per application requirements such that the losses in the low-Bₛₐₜ zones are within acceptable ranges.

The material zones 142 may be formed of materials commonly associated with an inductor core, such as iron, iron powder, and ferrite, as well as other materials not normally associated with an inductor core, such as non-ferrous materials, insulating materials, low or non-conductive materials, or other suitable core materials or material combinations. Material selection is dependent upon the application and the desired permeability, saturation prevention, flux density and current associated therewith. The stated materials may also be used to form the cores described with respect to FIGS. 7-14.

Referring now to FIG. 7, a side close-up view of a portion of an inductor core 150 that has a serial structure 152 in accordance with an embodiment of the present invention is shown. The inductor core 150 has material zones 154 that are coupled in a cascading or serial arrangement. The material zones 154 may be in the form of layers and stacked or arranged side-to-side. Magnetic flux Φ″ is directed through each zone 154 in series or one at a time. With this arrangement, low-Bₛₐₜ zones become saturated first, and serve as low permeability gaps.

Referring now to FIG. 8, a side close-up view of a portion of an inductor core 160 that has a parallel structure 162 in accordance with another embodiment of the present invention is shown. The inductor core 160 has material zones 164 that are coupled in parallel. Magnetic flux Φ is divided into parallel paths 166 that are directed through each material zone 164 simultaneously. Initially, the paths 166 with higher permeability attract more flux until they are saturated, which decreases effective permeability of the overall structure as current is increased beyond the saturation point.

Referring now to FIG. 9, a side close-up view of a portion of an inductor core 170 that has both a serial and parallel structure 172 in accordance with another embodiment of the present invention is shown. The inductor core 170 is similar to the inductor core 140. The material zones 174 of the inductor 170 are coupled and arbitrarily located relative to each other, which is basically the combination of the embodiments in FIGS. 7 and 8.

The boundaries between the material zones 154, 164, and 174, shown in FIGS. 7-9, may be arbitrary, as shown. The material zones 154, 164, and 174 have different permeability and associated magnetic saturation flux density.

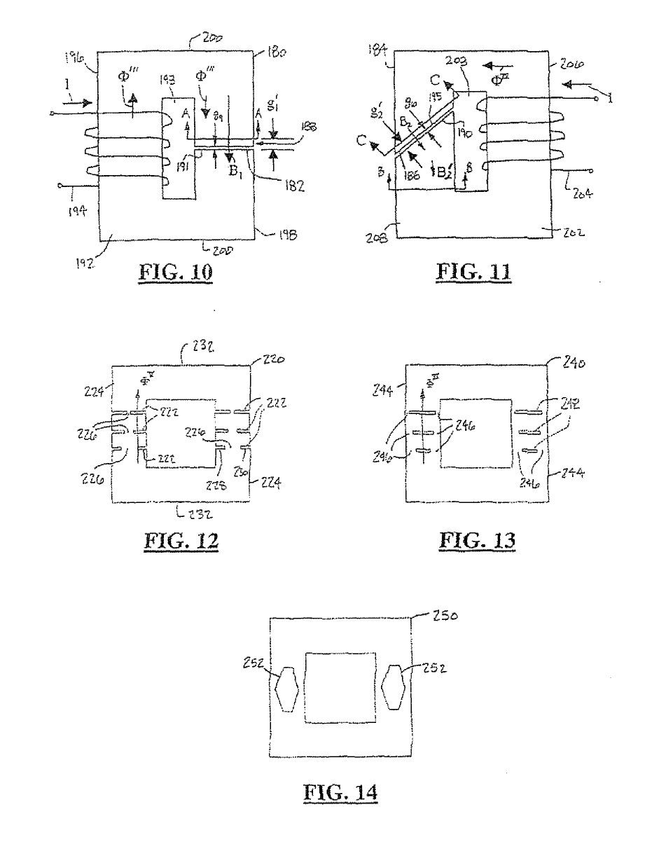

The embodiments provided with respect to the following FIGS. 10-11 are illustrated examples of serial configurations, as similarly described with respect to FIG. 7.

Referring now to FIGS. 10 and 11, a side view of a first inductor 180 incorporating a lateral member 182 with lower saturation flux density than that of the first main core 192 in a perpendicular magnetic flux flow orientation, and a side view of a second inductor 184 incorporating a tilted member 186 with lower saturation flux density than that of the first main core 202 in a tilted magnetic flux flow orientation are shown in accordance with yet another embodiment of the present invention. Since the member 182 is with lower saturation flux density, it becomes saturated before the main core 192 does. The permeability of the member 182 varies as a function of loading condition therefore serves as a permeability-varying member. Member 186 serves a similar function. The first inductor 180 can be with a lateral gap 188 that is oriented approximately perpendicular to a magnetic flux path Φ′″. The second inductor 184 can be with a tilted gap 190. The first inductor 180 includes a first core 192 with a window 193 and a first winding 194. The shapes, types, and styles of the inductor core 192, as well as the other inductors cores described herein may vary per application. The first winding 194 is wound about a first member 196 of the first core 192. The lateral gap 188 extends across a second member 198 opposite the first member 196. The magnetic flux flow path Φ′″ follows and is defined by the members 196, 198, and 200 of the first core 192.

The second inductor 184 is similar to the first inductor 180. However, instead of having a perpendicularly oriented gap, the second inductor 184 has the diagonally oriented or tilted gap 190. The tilted gap 190 is in a non-perpendicular arrangement relative to the magnetic flux flow path Φ^{IV} passing through the second inductor 184. The second inductor 184 has a second core 202 with a second window 203 and a second winding 204. The second winding 204 is wound about a core member 206, opposite the tilted gap 190. It is also understood that the gaps can be with arbitrary boundaries.

The gaps 188 and 190 have inserts or the permeability-varying members 182 and 186 disposed therein. Insert gaps 188 and 190 may exist between the permeability-varying members 182 and 186 and the cores 192 and 202. The insert gaps 188 and 190 may be due to manufacturing tolerances. The permeability members 182 and 186 may completely or partially fill the gaps 188 and 190, as shown. As shown, narrow gaps 191 and 195, having gap lengths g9 and g10, respectively, exist between the permeability-varying members 182 and 186 and the members 198 and 208. The permeability-varying members 182 and 186 are formed of a material or a combination of materials that have a high permeability at low load and a low magnetic saturation flux density. The permeability-varying members 182 and 186 may be formed of laminated steel, iron powder, ferrite, or other suitable materials. The permeability-varying members 182 and 186 may be formed integrally with the cores 192 and 202 or may be bonded, welded, fastened, adhered, or attached via some other techniques known in the art. The effective overall permeability of the cores 192 and 202 at low current is high, as well as inductance. At high current, some or all of the permeability-varying members 182 and 186 become saturated and thus exhibit low permeability, which reduces overall equivalent permeability of the cores 192 and 202. The overall permeability at full load is tunable. The cores 192 and 202, including the permeability-varying members 182 and 186, may exhibit the same inductance at low load as well as at high load, depending upon the geometry of the permeability-varying members 182 and 186.

The embodiments provided with respect to the following FIGS. 12-14 are illustrated examples of parallel configurations, as similarly described with respect to FIG. 8. In the embodiments of FIGS. 12-14, a part of the cores shown therein are “cut-out.” This forces the magnetic flux associated therewith to concentrate in the remaining narrow core sections. At high current, the narrow core sections become saturated first and have a reduced effective permeability.

Referring now to FIG. 12, a side view of an inductor core 220 incorporating member edge gaps 222 in accordance with another embodiment of the present invention is shown. The inductor core 220 has member edge gaps 222 that, as shown, extend laterally across core members 224 perpendicular to the direction of the magnetic flux flow Φ^{V}. The gap can be filled with permeability-varying or other proper materials. The narrow core member sections 226 that exist between laterally adjacent edge gaps, such as gaps 228 and 230, may be referred to as bridges. The bridges 226 may be of varying width, as shown. The edge gaps 222 may extend in other directions and may be incorporated in any of the core members 224 and 232. Of course, the edge gaps 222, may be of various size, length, orientation, and may be in a variety of boundaries and configurations. The edge gaps 222 may be arranged non-perpendicularly or diagonally to the direction of magnetic flux flow.

Referring now to FIG. 13, a side view of an inductor core 240 incorporating rectangular-shaped internal member gaps 242 in accordance with another embodiment of the present invention is shown. The internal member gaps 242, as shown, also extend laterally across core members 244 perpendicular to the magnetic flux flow Φ^{VI}. The internal member gaps 242 partially extend across the core members 244 and have narrow associated core member support sections 246 on each side thereof. The number, width, length, size, shape, orientation, and configuration of the internal member gaps 242 may vary per application, and they can be filled with permeability-varying or other proper materials. The direction of magnetic flux flow is shown in FIGS. 12 and 13, for example purposes, and may be different per application. FIG. 14 provides another internal member gap example.

Referring now to FIG. 14, a side view of an inductor core 250 incorporating hexagonally-shaped internal member gaps 252 in accordance with another embodiment of the present invention is shown. The gaps 252 have varying width and length, and they can be filled with permeability-varying or other proper materials. Again, this is only one example; there are an infinite number of other arrangements and configurations.

The present invention provides inductors that may be of the same size as prior inductors, but rather they have improved inductance at low load while equal inductance and equal or greater saturation prevention at high load.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An inductor comprising:
a core comprising at least one member having a plurality of material zones, said material zones having a plurality of associated saturation flux density; and
a winding coupled to said at least one member and configured for magnetic flux generation in said core.

2. An inductor as in claim 1 wherein said core comprising at least one window.

3. An inductor as in claim 1 wherein said plurality of material zones are in a serial arrangement.

4. An inductor as in claim 3 wherein said plurality of material zones comprise:
a first core member; and
a second core member coupled in series with and having a different saturation flux density and a different permeability than said first core member.

5. An inductor as in claim 4 wherein said second core member is oriented relative and perpendicular to a magnetic flux path through said first core member.

6. An inductor as in claim 4 wherein said second core member is oriented relative and non-perpendicular to a magnetic flux path through said first core member.

7. An inductor as in claim 1 wherein said plurality of material zones are in a parallel arrangement.

8. An inductor as in claim 7 wherein said core comprises a core member having at least one gap, each of said at least one gap extending only partially across said core member.

9. An inductor as in claim 1 wherein said plurality of material zones are in a serial and parallel arrangement.

10. An inductor as in claim 1 wherein said plurality of material zones have arbitrary boundaries.

11. An inductor as in claim 1 wherein said plurality of material zones comprise:
a first material zone having a first saturation flux density and a first permeability; and
a second material zone having a second saturation flux density and a second permeability.

12. An inductor as in claim 11 wherein said first saturation flux density is greater than said second saturation flux density.

13. An inductor comprising:
a core having a first saturation flux density and comprising at least one member having at least one gap;
at least one permeability-varying member disposed within said at least one gap and having a second saturation flux density that is less than said first saturation flux density; and
a winding coupled to said at least one member and configured for magnetic flux generation in said core.

14. An inductor as in claim 13 wherein at least one of said at least one gap is disposed between said core and said at least one permeability-varying member.

15. An inductor as in claim 13 wherein said core comprises a plurality of gaps and a plurality of permeability-varying members disposed within said plurality of gaps.

16. An inductor as in claim 13 wherein said at least one permeability-varying member is oriented relative and perpendicular to a magnetic flux path through said core.

17. An inductor as in claim 13 wherein said at least one permeability-varying member is oriented relative and non-perpendicular to a magnetic flux path through said core.

18. An electronic circuit comprising:
at least one input terminal;
at least one inductor coupled to said at least one input terminal and comprising;
a core comprising at least one member having a plurality of material zones, said material zones having a plurality of associated permeability and a plurality of associated saturation flux density; and
a winding coupled to said at least one member and configured for magnetic flux generation in said core; and
at least one output terminal coupled to and receiving current from said inductor.

19. An inductor as in claim 18 wherein said plurality of material zones comprise:
a first material zone has a first permeability and a first saturation flux density; and
a second material zone has a second permeability and a second saturation flux density that is less than said first saturation flux density.

20. An inductor as in claim 18 wherein one of said plurality of material zones facilitates magnetic flux flow in said core during a first condition and reduces magnetic flux flow in said core during a second condition.
